(19) United States
(12) Patent Application Publication
(10) Pub. No.: US 2010/0308949 A1
(43) Pub. Date: Dec. 9, 2010

(54) MULTILAYER POWER INDUCTOR USING SHEETS CHARGED WITH SOFT MAGNETIC METAL POWDER

(75) Inventors: Sung Tae Lim, Pyeongtaek (KR); Tae Kyung Lee, Incheon (KR); Doo In Kang, Incheon (KR)

Correspondence Address: NIXON PEABODY, LLP, 401 9TH STREET, NW, SUITE 900, WASHINGTON, DC, 20004-2128, US

(73) Assignee: Chang Sung Corporation, Chungcheongbuk-do (KR)

(21) Appl. No.: 12/744,930

(22) PCT Filed: Mar. 3, 2009
(86) PCT No.: PCT/KR2009/001037

§ 371 Date: May 26, 2010

(30) Foreign Application Priority Data
Mar. 11, 2008 (KR) 1020080022361

(51) Int. Cl. H01F 27/255; H01F 27/24

(52) U.S. Cl. 336/218; 336/233

(57) ABSTRACT

The present invention relates to a multilayer power inductor in which sheets are charged with a soft magnetic metal alloy powder having a shape optimized along a magnetic path, pattern circuits made from conductive materials are formed on the sheets, and via holes are formed through the sheets to easily connect pattern circuits. The power inductor of the present invention is manufactured by stacking the above-described sheets into multiple layers. The sheets of the inductor of the present invention are charged with soft magnetic metal powder having a high magnetization density, and fine gaps are distributed among the powder the shape of which is optimized along a magnetic path to ensure high current superposition characteristics which allow the use of 1A to several tens of A without causing leakage flux, and ensure stable inductance to a high frequency domain of the 10 MHz band. Further, the present invention is advantageous as it provides an inductor with a thin width, a large area, high inductance and high direct current superposition characteristics.

### TECHNICAL FIELD

The present invention relates to a multilayer power inductor with high current superposition characteristics and high-frequency characteristics, particularly to a multilayer power inductor using magnetic sheets charged with soft magnetic metal powder as magnetic substances.

### BACKGROUND ART

Due to the diversification of portable devices, types of the operating power supplies for the power circuit of a portable device have been diversified. Operating power supplies are used for portable devices such as an LCD drive, power amplifier module, base band IC, etc. Each of the power supplies requires a different voltage for operation, and requires a power circuit for converting a voltage supplied from a power source to an operating voltage of its circuit. Due to the decrease in the size of semiconductors, the voltage of their power circuits has decreased, and thus even a small change in voltage may lead to malfunction of the devices. In order to prevent such problem, in general, a distributed power (POL) scheme is used, where a power supply is arranged near each LSI to reduce voltage fluctuation by using the line inductance between a power source and the LSI or wiring resistance. As a result, portable devices require power sources for controlling each LSI, and have many power circuits therein.

Power circuits of a portable device are categorized into two major groups: linear regulators and switching regulators. Recent trends have been towards reducing power consumption to lengthen battery life, and accordingly switching regulators (generally called DC-DC converters) suffering less power loss in voltage conversion have been more commonly used.

Meanwhile, in terms of miniaturization, a DC-DC converter includes additional attached parts such as an inductor, condenser, etc., which increases the size of a power circuit; thus, in order to miniaturize the device, it is necessary to miniaturize those parts first. These parts can be miniaturized by decreasing the required constants of inductors or condensers by increasing the switching frequency of a DC-DC converter.

Recently, due to advance in the performance of IC according to the advance of semiconductor manufacture technology, high frequency has been further progressed. Under this trend, a wire inductor, produced by coiling a wire around a magnetic metallic material, has been typically used as a power inductor for the circuit of a DC-DC converter. However, such inductors have an intrinsic limitation in miniaturization.

Accordingly, with the advance in ceramic materials technology, a spotlight has been on a multilayer power inductor.

Ferrite-based metal oxides, commonly used as magnetic substance of a multilayer power inductor, have high permeability and electrical resistance while having low saturation flux density. Thus, ferrite-based metal oxides achieve low inductance due to magnetic saturation, and have poor direct current superposition characteristics.

In addition, in conventional multilayer power inductors, in order to ensure direct current superposition characteristics, a nonmagnetic substance layer for forming a gap needs to be inserted between layers.

In addition, in the process for the manufacture of an inductor using ferrite, a circuit is placed on a ferrite substrate, and then has to be sintered; however, the inductor may be distorted during the sintering process, which poses an obstacle in ensuring inductance and direct current superposition characteristics higher than a certain level. Thus, such inductors cannot be designed to have a large width. In particular, under the recent circumstances where the size of inductors have been reduced and products with a width of 1 mm or less are manufactured, the width of inductors is much more limited; thus, under this circumstance, an inductor using ferrite cannot achieve various types of inductance, and current superposition characteristics.

### DETAILED DESCRIPTION OF THE INVENTION

### Problems to be Solved

The present invention was conceived to solve said problems. An objective of the present invention is to provide a power inductor without leakage of magnetic flux and limitation in current due to magnetic saturation.

Another object of the present invention is to provide a power inductor which allows the use of a high frequency band of 10 MHz band.

Another object of the present invention is to provide a high capacity, ultrathin power inductor which can be used without limitation in width.

Yet another object of the present invention is to provide a multilayer power inductor ensuring high direct current superposition characteristics without use of a separate nonmagnetic substance.

### Technical Means for Solving the Problems

In order to achieve the above objectives, the present invention provides a multilayer power inductor using sheets charged with soft magnetic metal powder, characterized in that magnetic substances having one face to which are attached pattern circuits are stacked into multiple layers, the magnetic substances are connected through via holes, and the magnetic substances are sheets charged with soft magnetic metal powder.

In addition, the present invention provides a multilayer power inductor charged with soft magnetic metal powder, characterized in that the soft magnetic metal powder is anisotropic and is arranged parallel or vertical to a face of the sheet.

In addition, the present invention provides a multilayer power inductor using sheets charged with soft magnetic metal powder, characterized in that the soft magnetic metal powder is anisotropic and is arranged parallel to a magnetic path.

In addition, the present invention provides a multilayer power inductor according to claim 1, characterized in that the soft magnetic metal powder is anisotropic and is arranged parallel to a face of the sheet in the upper and lower parts of the multilayer and the soft magnetic metal powder is isotropic in the middle part of the multilayer.

### EFFECTS OF THE INVENTION

Unlike conventional power conductors, the present invention can obtain relatively high frequency and high-capacity saturation current. In addition, by using soft magnetic metal powder sheets, the present invention can provide a thin inductor which does not have limitations in width in an economical way, and thus makes it possible to easily provide a slim laptop computer, cellular phone, display device, etc.

### BRIEF DESCRIPTION OF DRAWINGS

FIG. 1. shows an exploded perspective view of a multiplayer power inductor according to the present invention.

FIG. 2 illustrates a case where anisotropic powders are arranged parallel to a face of the sheet.

FIG. 3 illustrates a case where anisotropic powders are arranged vertically to a face of the sheet.

FIG. 4 illustrates a case where anisotropic powders are arranged parallel to a face of the sheet in the upper and lower parts of the inductor and isotropic powders are arranged in the middle part of the inductor.

FIG. 5 illustrates a case where anisotropic powders are arranged parallel to a face of the sheet in the upper and lower parts of the inductor and anisotropic powders are arranged vertically to a face of the sheet in the middle part of the inductor.

FIG. 6 shows a graph indicating changes in inductance according to the frequency of a multilayer power inductor.

FIG. 7 shows a graph indicating changes in inductance according to the current of a multilayer power inductor.

### BEST MODES FOR CARRYING OUT THE INVENTION

Hereinafter, the present invention will be described with reference to the drawings.

FIG. 1 illustrates a schematic drawing of the power inductor according to the present invention.

For the sake of simplicity, we will not repeat the same reference numeral once mentioned.

A pattern circuit (10) manufactured separately is attached to an upper face of a magnetic sheet (2) manufactured according to the present invention to form a layer.

Here, the magnetic sheet (2) is made of soft magnetic alloy powder.

As said soft magnetic alloy powder, anisotropic or isotropic powder in the form of a flat flake is used. In addition, as said alloy powder, Mo-permalloy, permalloy, sendust alloy (Fe—Si—Al alloy), Fe—Si alloy, etc. may be used.

The pattern circuit (10) is separately manufactured using conductive materials according to a conventional manner and is formed on one face of the magnetic sheet (2).

In the pattern circuit (10), a main circuit unit (12) is formed in the form of a coil, and a first terminal unit (14) and a second terminal unit (16) are respectively formed at both ends of the main circuit unit (12).

A plurality of magnetic sheets (2) to which are attached the pattern circuits (10) are stacked into multiple layers to form a power inductor.

Here, in order to connect each of the stacked multiplayer pattern circuit (10), a hole is made in each magnetic sheet (2) and is coated with a conductive material, so that upper and lower pattern circuits (10) are connected. Said hole is called via hole, and FIG. 1 exemplifies four via holes (20, 22, 24, 26) on the faces of the respective magnetic sheets (2).

As illustrated in FIG. 1, via holes (20, 22, 24, 26) of each layer connect a first terminal unit (14) and a second terminal unit (16) in different manners as needed. Thus, pattern circuits (10) may be connected or may not be connected vertically in the manner that they are connected or are not connected through each via hole as needed.

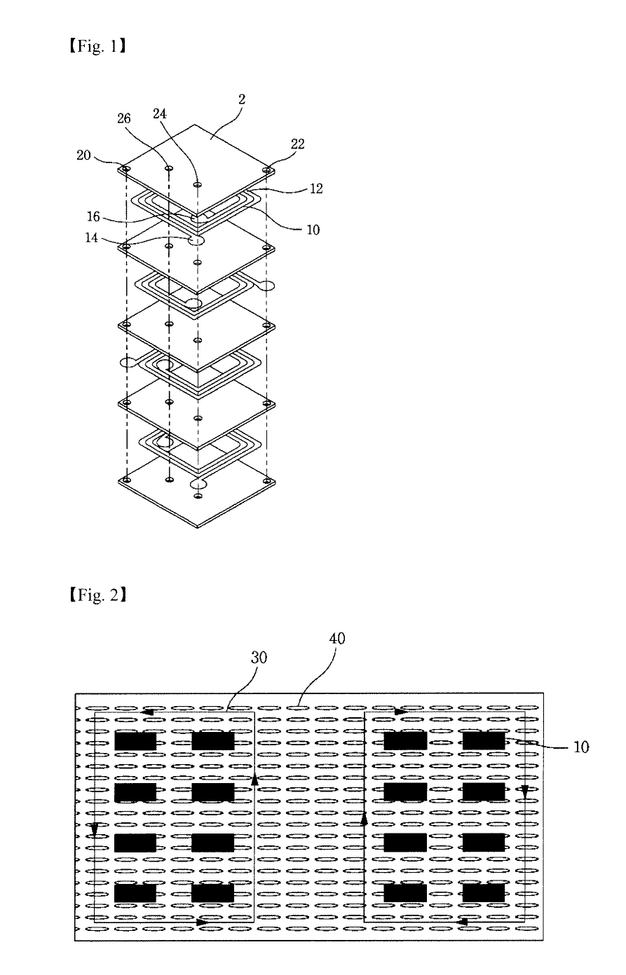

FIGS. 2 to 5 are sectional views of the inductor of FIG. 1 cut through thickness, illustrating an arrangement of soft magnetic metal powder in the magnetic sheet.

Reference Numeral 30 of FIGS. 2 to 5 represents a magnetic path occurring in the inductor. When a current flows in pattern circuits (10), a magnetic path (30) occurs in an upward direction in a middle part.

FIG. 2 illustrate an arrangement where anisotropic alloy powder (40) is arranged parallel to a face of the magnetic sheet (2), and in this case, the length direction of the anisotropic alloy powder (40) is arranged parallel to the magnetic path (30) in the upper and lower parts of the inductor, but it is arranged vertically to the magnetic path in the middle part or outer part.

When the length direction of said anisotropic alloy powder is parallel to the magnetic path, inductance increases.

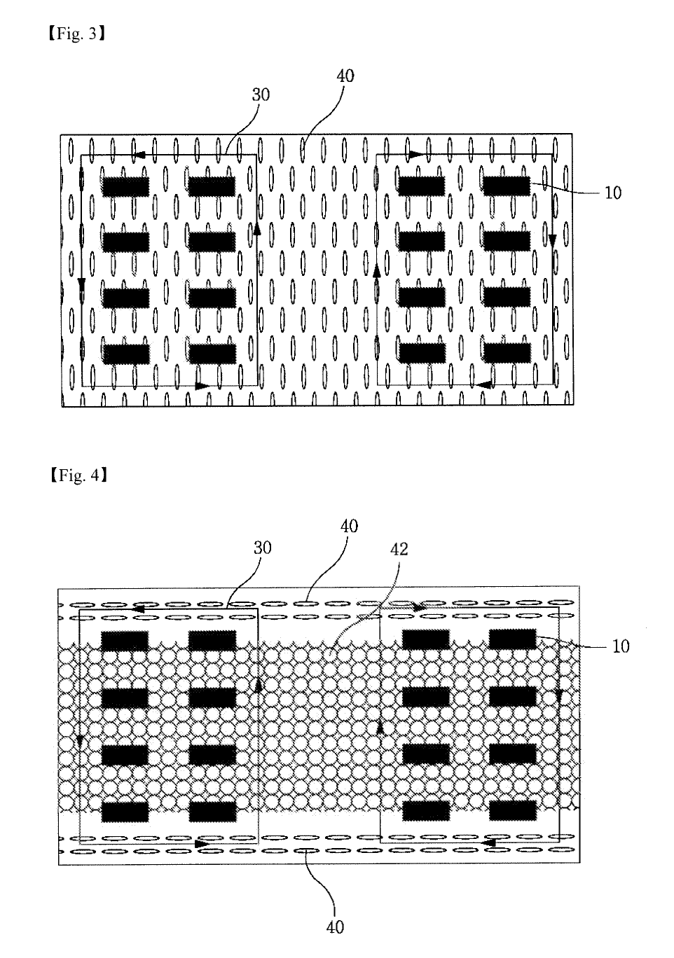

FIG. 3 illustrates an arrangement where anisotropic alloy powder (40) is arranged vertically to the magnetic sheet (2), and in this case, the length direction of the anisotropic alloy powder (40) is vertical to the magnetic path (30) in the upper and lower parts of the inductor, but it is parallel in the middle part or outer part.

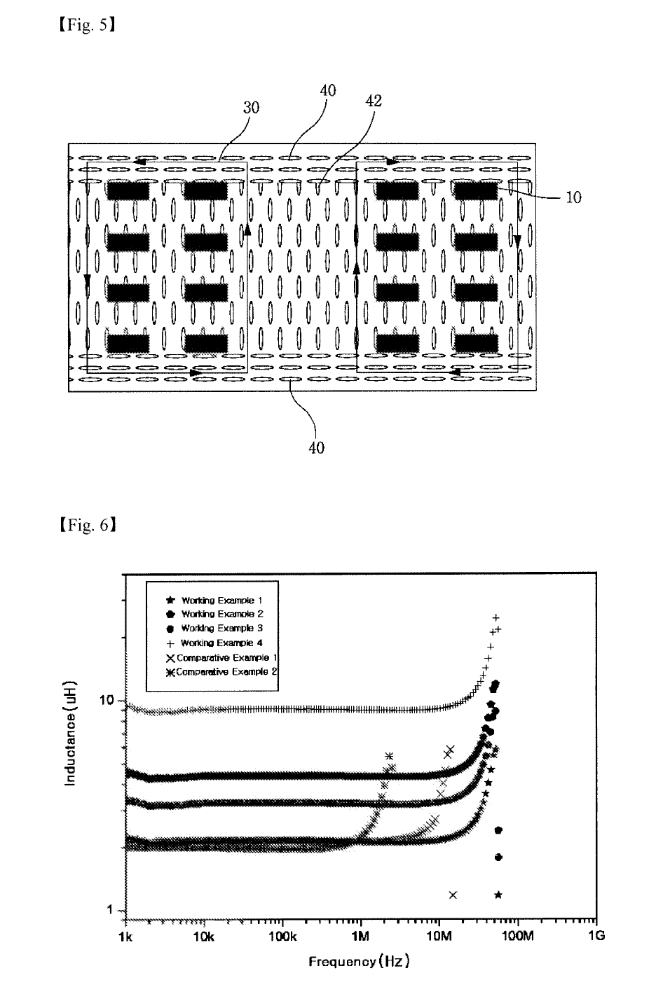

FIG. 4 illustrates an arrangement where anisotropic alloy powder (40) is arranged in the upper and lower parts of the inductor and isotropic alloy powder (42) is arranged in the middle part and outer part. In this case, it is arranged parallel in the upper and lower parts of the inductor, but there is no parallel or vertical arrangement in the middle part and the outer part since isotropic powder is arranged there.

FIG. 5 is another embodiment showing that anisotropic alloy powder (40) is arranged parallel to the magnetic sheet (2) in the upper and lower parts of the inductor, and is arranged vertically in the middle part and the outer part. In this case, as shown in the Figure, in all positions, the length direction of the anisotropic alloy powder (40) is arranged parallel to the direction of the magnetic path (30).

Hereinafter, a process for manufacturing according to the present invention will be described.

Anisotropic or isotropic soft magnetic metal powder is prepared to implement optimal characteristics of an inductor along a magnetic path.

For preparing anisotropic powder, soft magnetic metal powder is milled in an attrition mill to be manufactured in a flake form.

The powder is dispersed in a resin in a high density to manufacture a magnetic sheet.

Circuits made of conductive material are put on an upper face of the magnetic sheet; here, circuits, with which a considerable number of inductors can be manufactured in a predetermined area, are arranged to ensure economical efficiency.

Magnetic sheets with pattern circuits on them are stacked with as many layers as necessary; herein, it is important to position the arrangement of pattern circuits on a predetermined place.

Thereafter, via holes are made in the inductor where the circuits are already stacked, and are connected by using coating or conductive paste for them between layers to be connected.

The final product is cut into a necessary size.

The cut surface is coated with an insulation agent by a method of dipping or using a roller to ensure reliability.

### Working Example 1

Sendust flakes prepared by milling sendust powder having an average particle size of 70 μm for 6 hours in an attrition mill, and EPDM employed as an organic high molecule matrix material are distributed at a ratio of 8:2 by weight, and then a green sheet having a thickness of 100 μm is prepared according to a doctor blade method.

Said green sheet is thermal pressed for 1 hour at 150° C. by using a hot press to prepare a magnetic sheet.

A Cu foil is thermal pressed on an upper face of the magnetic sheet and then it is etched to implement a conductive circuit.

Magnetic sheets with circuits arranged on them are stacked into four layers, and via holes are made and they are coated with copper to connect the circuits. The final product is cut in a necessary size by a fine cutter. In addition, in order to ensure reliability, the cut surface is coated by dipping epoxy having heat-resisting property. FIG. 2 shows working example 1.

### Working Example 2

Anisotropic sheets are prepared in the same manner as in working example 1, and then the prepared sheets are stacked as thick as necessary and thermal pressed for 1 hour at 150° C. by using hot press to prepare a magnetic sheet having a desired thickness. The prepared sheets are cut in a vertical direction by using a cutter, and anisotropic sheets was arranged vertically.

FIG. 3 shows working example 2.

### Working Example 3

This is the same as working example 1, except that on the upper and lower sheets, anisotropic powder was arranged parallel, and that on the two middles sheets, isotropic powder was arranged. FIG. 4 shows working example 3.

### Working Example 4

This is the same as invention example 1, except that on the upper and lower sheets, anisotropic powder was arranged parallel, and that on the two middle sheets, anisotropic powder was vertically arranged. FIG. 5 shows working example 4.

### Comparative Example 1

Comparative example 1 is a multiplayer power inductor using a ferrite green sheet as a magnetic substance, wherein electrode patters are formed in the magnetic substance where four oxide ferrite magnetic layers are stacked and integrally formed.

### Comparative Example 2

Comparative example 2 is a ferrite wound-type power inductor using a conventional oxide ferrite magnetic substance, where a conductor is coiled around a magnetic core and an air gap is provided between the magnetic core and a ferrite case.

Inductance of the inductor prepared according to the working examples and comparative examples was measured using an impedance analyzer (HP 4294A) in a frequency band of 1 kHz˜110 MHz, and their saturation currents were measured using an LCR meter (HP 4284A).

Here, the saturation current means a current value at the time the current is reduced by 30% when a DC superposition is applied.

In addition, an allowable frequency refers to a switching frequency domain allowable within 20% compared to an initial value when a switching frequency is increased.

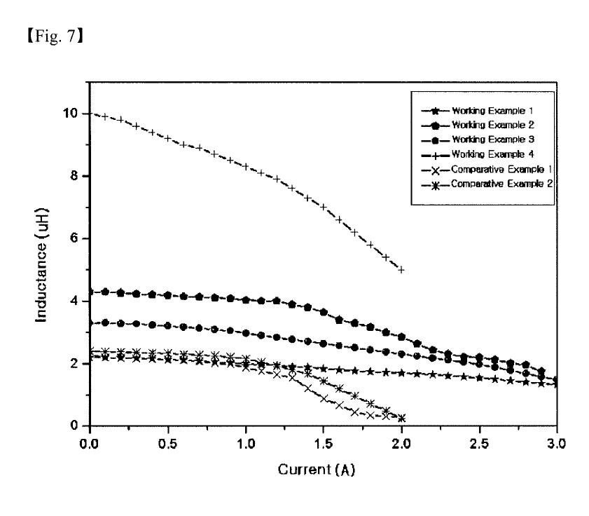

Results according to the above measurement methods are summarized in Table 1 and FIGS. 6 and 7.

TABLE 1

| | Allowable | Inductance | Saturation current |
|---|---|---|---|
| Classification | frequency (MHz) | (μH) | (A) |
| Working example 1 | 10 | 2.2 | 2.5 |
| Working example 2 | 10 | 4.3 | 2.0 |
| Working example 3 | 10 | 3.3 | 2.0 |
| Working example 4 | 10 | 10 | 1.5 |
| Comparative | 10 | 2.2 | 1.3 |
| example 1 | | | |
| Comparative | 5 | 2.2 | 1.3 |
| example 2 | | | |

As shown in Table 1 and FIG. 6, allowable frequencies of all the working examples reach 10 MHz.

FIG. 6 is a graph indicating change in inductance according to the frequency. When the frequency increases, the inductance of the comparative examples greatly increased within 10 MHz at maximum. In contrast, the inductance of the working examples increased in a much higher state than 10 MHz, so their allowable frequencies are very high.

In addition, it is shown that the saturation current of working example 1 remarkably increased over the comparative examples, and the inductance of working examples 2 and 3 slightly increased and their saturation currents also increased very high, and in case of the working example 4, the inductance remarkably increased.

FIG. 7 illustrates change in inductance according to the current, where the comparative examples are already saturated at about 1.3 A, whereas the working examples show higher saturation current than that.

1. Multilayer power inductor using sheets charged with soft magnetic metal powder, characterized in that
magnetic substances having one face attached with pattern circuits are stacked into multiple layers,
the magnetic substances are connected through via holes, and
the magnetic substances are sheets charged with soft magnetic metal powder.

2. Multilayer power inductor according to claim 1, characterized in that
the soft magnetic metal powder is anisotropic and is arranged parallel or vertically to face of the sheet.

3. Multilayer power inductor according to claim 1, characterized in that
the soft magnetic metal powder is anisotropic and is arranged parallel to magnetic path.

4. Multilayer power inductor according to claim 1, characterized in that
the soft magnetic metal powder is anisotropic and is arranged parallel to face of the sheet in the upper and lower parts of the multilayer and
the soft magnetic metal powder is isotropic in the middle part of the multilayer.
